(19) United States
(12) Patent Application Publication
(10) Pub. No.: US 2007/0038710 A1
(43) Pub. Date: Feb. 15, 2007

(54) Managing redundant email

(76) Inventors: Yongcheng Li, Cary, NC (US); Yuping Connie Wu, Cary, NC (US); Chunshan Andy Zhang, Cary, NC (US)

Correspondence Address: IBM CORPORATION, 3039 CORNWALLIS RD., DEPT. T81 / B503, PO BOX 12195, REASEARCH TRIANGLE PARK, NC, 27709, US

(21) Appl. No.: 11/202,888

(22) Filed: Aug. 12, 2005

(51) Int. Cl. G06F 15/16

(52) U.S. Cl. 709/206

(57) ABSTRACT

Methods and computer program products for managing redundant email. According to one aspect of the invention, a determination is made as to whether a first email is contained in a second email. If the first email is contained in the second email, the first email is purged. Email attachments may be transferred from the first email to the second email, so that the attachments are not lost when the first email is purged.

### BACKGROUND OF THE INVENTION

The invention concerns electronic mail (email), and more particularly concerns efficient methods and computer program products for managing email so as to minimize the cost and inconvenience of maintaining redundant email records.

Email has become so successful and so widely accepted that email archives fill quickly to capacity, and beyond. This can be a mixed blessing, however, as large accumulations of email require large memories for storage, and present a challenge to anyone who needs to locate and retrieve specific email for further reference.

Sometimes, perhaps often, email can be redundant. For example, a first person sends an email to a second person. The second person answers with a reply email that contains his or her response appended to the original email. The first person receives the reply, appends another set of remarks, and forwards the ever-growing email back to the second person. Thus, as such an exchange goes back and forth, a large number of individual emails may accumulate in an email server's archive, most of which are redundant. This situation may become aggravated when the first person's email goes out to a group of recipients, each of whom then replies to the others in the group, and so on, thus precipitating an email blizzard.

Consequently, there is a need for effective methods and computer program products to manage redundant email, in order to control the amount of memory needed by an email archive, and to better enable users to locate particular email in the archive.

### SUMMARY

The present invention includes methods and computer program products for managing redundant email. According to one aspect of the invention, a determination is made as to whether a first email is contained in a second email. If the first email is contained in the second email, the first email is purged. Email attachments may be transferred from the first email to the second email, so that the attachments are not lost when the first email is purged.

### BRIEF DESCRIPTION OF THE DRAWINGS

FIG. 1 shows a block diagram depicting an exemplary email system.

FIG. 2 is a flowchart that shows aspects of a method for managing redundant email in an email system such as the exemplary email system of FIG. 1.

FIG. 3 is a flowchart that shows aspects of a method for determining whether a first email is contained in a second email.

FIG. 4 is a flowchart that shows further aspects of a method for managing redundant email.

### DETAILED DESCRIPTION

The present invention will now be described more fully hereinafter, with reference to the accompanying drawings, in which illustrative embodiments of the invention are shown. Throughout the drawings, like numbers refer to like elements.

The invention may, however, be embodied in many different forms, and should not be construed as limited to the embodiments set forth herein; rather, these embodiments are provided so that the disclosure will be thorough and complete, and will fully convey the scope of the invention to those skilled in the art.

As will be appreciated by one of skill in the art, the present invention may be embodied as a method, data processing system, or computer program product. Accordingly, the present invention may take the form of an embodiment entirely in hardware, entirely in software, or in a combination of aspects in hardware and software referred to as circuits and modules.

Furthermore, the present invention may take the form of a computer program product on a computer-usable storage medium having computer-usable program code embodied in the medium. Any suitable computer-readable medium may be utilized, including hard disks, CD-ROMs, optical storage devices, magnetic storage devices, and transmission media such as those supporting the Internet or an intranet.

Computer program code for carrying out operations of the present invention may be written in an object oriented programming language such as Java, Smalltalk, or C++. However, the computer program code for carrying out operations of the present invention may also be written in conventional procedural programming languages, such as the C programming language. The program code may execute entirely on the user's computer, partly on the user's computer, as a stand-alone software package, partly on the user's computer and partly on a remote computer, or entirely on a remote computer. The remote computer may be connected to the user's computer through a local area network or a wide area network, or the connection may be made to an external computer, for example through the Internet using an Internet Service Provider.

The present invention is described below with reference to flowchart illustrations and/or block diagrams of methods, apparatus (systems), and computer program products according to embodiments of the invention. It will be understood that each block of the flowchart illustrations and/or block diagrams can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions and/or acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instruction means which implement the functions or acts specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions and/or acts specified in the flowchart and/or block diagram block or blocks.

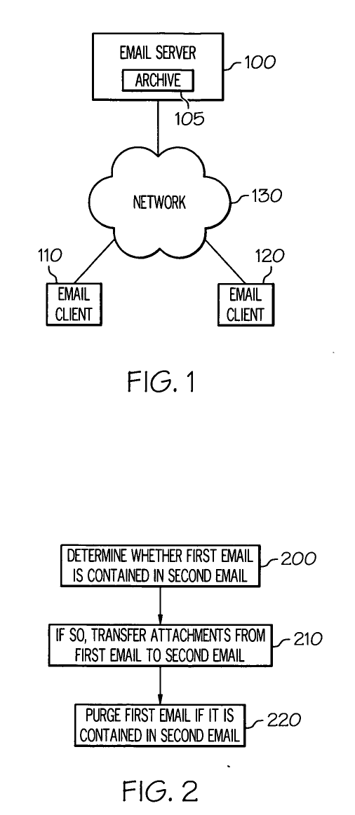

FIG. 1 shows a block diagram depicting an exemplary email system. Here, an email server 100 provides email service to email clients 110, 120. In this exemplary system, the email server 100 and the email clients 110, 120 are connected together by a communication network 130. The network 130 may be a local area network, a metropolitan area network, or a wide area network.

In one scenario, a user of email client 110 might send an initial email to the user of email client 120. The initial email may be stored in memory in an archive 105 in the email server 100. The user of the email client 120 may receive the initial email, expand the initial email by appending remarks, and send the expanded version back to the email client 110 as an initial reply. The initial reply, which contains the initial email, may also be stored in the archive 105. Upon receiving the initial reply, the user of email client 110 may expand the initial reply by appending remarks, and return the expanded initial reply to the email client 120. The expanded version of the initial reply may also be stored in the archive 105.

At this point, the archive 105 has in its storage the initial email; the initial reply, which contains the initial email; and the expanded version of the initial reply, which contains the initial reply, and which therefore also contains the initial email. Thus, as the message is expanded and sent back and forth between email client 110 and email client 120, the archive 105 may accumulate a thread or sequence of related emails. Maintaining this accumulation may be expensive, due to ever-increasing demands for memory and storage in the archive 105, and, as the number of stored email grows, may frustrate someone who needs to search the archive 105 looking for a particular item.

FIG. 2 shows aspects of a method for managing redundant email in an email system such as the exemplary email system of FIG. 1. For any two emails, a determination is made, as described more fully below, as to whether a first email is contained in a second email (step 200), or, equivalently, whether the second email contains the first email. For example, the initial reply introduced above contains the initial email introduced above. If the first email is contained in the second email, and if the first email includes any attachments that are not included in the second email, for example because the attachments were stripped when the second email was composed or sent, these attachments may be transferred onto the second email (step 210). If the second email is determined to contain the first email in step 200, the first email is then purged from the archive 105 (step 220).

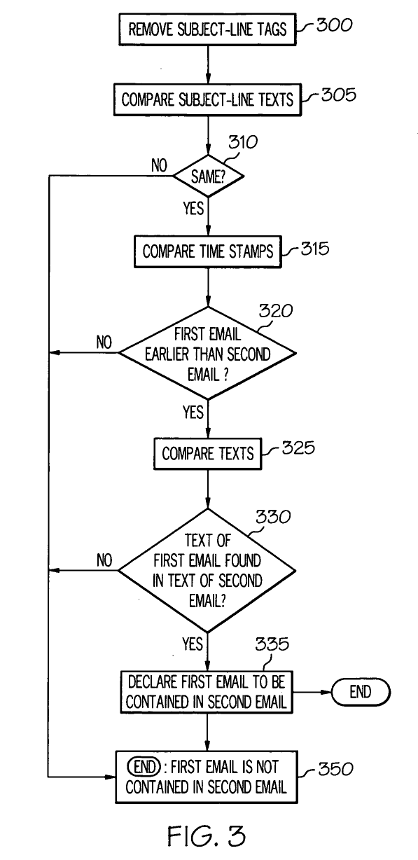

FIG. 3 shows aspects of a method for determining whether a first email is contained in a second email. Typically, each email has a subject line to identify the purpose of the email. In some cases, the subject line may be prefaced by a tag such as the tag “Re:” to indicate that the email is a response or “Fw:” to indicate that the email is something forwarded by another user. Such tags may be removed (step 300) to isolate the subject line text.

The subject line text of the first email and the subject line text of the second email may be compared (step 305). The specific method of comparison may take a number of different forms, all of which are encompassed by the invention. For example, a word-for-word match of the two subject line texts may be required in order to declare the subject lines to be the same. In another example, N out of M words may be required to match. In yet another example, one of the subject line texts and an excerpt from the other subject line text may be examined using sliding correlation with various offsets, and so forth.

If the subject line texts do not match (step 310, no), the first email is not contained in the second email, and the process ends (step 350). Otherwise (i.e., the subject line texts match; step 310, yes), a time stamp of the first email may be compared with a time stamp of the second email (step 315). If the first email is contained in the second email, the time stamp of the first email may be presumed to be earlier than the time stamp of the second email. If the time stamp of the first email is not earlier than the time stamp of the second email (step 320, no), the first email is not contained in the second email, and the process ends (step 350).

Otherwise (i.e., the time stamp of the first email is earlier than the time stamp of the second email (step 320, yes), text of the first email and text of the second email may be compared (step 325), to determine whether the text of the first email is contained in the text of the second email. Here, the text of an email is taken to be the natural language body of the email or the message conveyed by the email, as differentiated from the subject line text, the headers, identifiers, control characters, and so forth. Again, the specific method of comparison may take a number of different forms, all of which are encompassed by the invention. For example, the text of the first email may be compared with various excerpts of the text of the second email, using word-for-word comparison, N-out-of-M-words comparison, sliding correlation, and so forth. In some embodiments, hashed values of text may be used in the comparisons rather than text itself.

If the comparison of step 325 reveals that the text of the first email cannot be found in the text of the second email (step 330, no), the first email is not contained in the second email, and the process ends (step 350). Otherwise (i.e., the text of the first email is found in the second email; step 330, yes) the first email is declared to be contained in the second email (step 335).

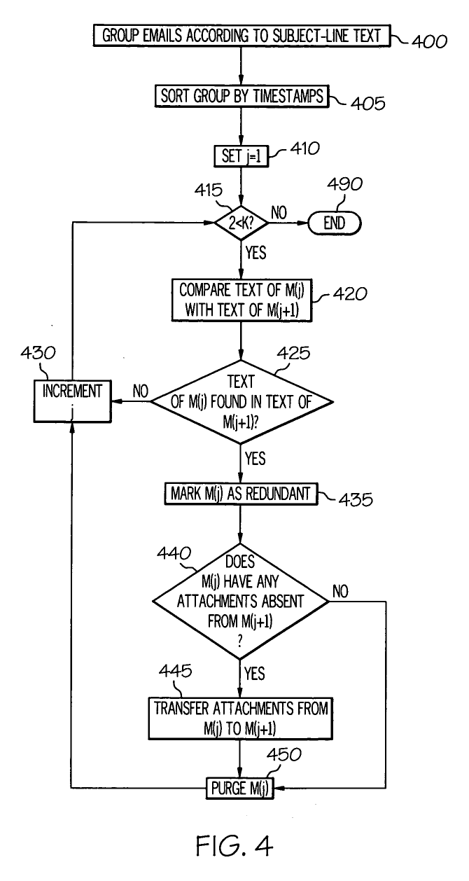

FIG. 4 shows further aspects of a method for managing redundant email. A plurality of emails having the same subject line text, where sameness is determined as described above, are grouped (step 400). Members of the group are sorted according to time stamps and indexed from 1 to K, where K is the number of emails in the group, to form a sequence according to time stamps (step 405). Email M(1) is the earliest email; email M(K) is the most recent. In the sequence, email M(i) and email M(i+1), for example, are said to be adjacent.

A loop counter j is set to the integer value 1 (step 410). The counter j is compared with K. If j is greater than or equal to K (step 415, no), the process ends (step 490). Otherwise (i.e., j is less than K; step 415, yes), text of the email M(j) is compared with text of the email M(j+1), as described above. If the text of email M(j) is not contained in the text of email M(j+1) (step 425, no), the counter j is incremented by one (step 430), and the process returns to step 415. Otherwise (i.e., the text of email M(j) is contained in the text of email M(j+1) (step 425, yes), email M(j) is marked as redundant (step 435).

A determination may be made as to whether email M(j) has attachments that are absent from email M(j+1). If email M(j) has any such attachments (step 440, yes), the attachments are transferred to email M(j+1) (step 445), and email M(j) is purged from the archive 105 (step 450). Counter j is incremented (step 430), and the process continues with step 415. If email M(j) does not have any attachments that are absent from email M(j+1) (step 440, no), email M(j) is purged from the archive 105 (step 450), counter j is incremented (step 430), and the process continues with step 415.

Although the foregoing has described methods and computer program products for managing redundant email, the description of the invention is illustrative rather than limiting; the invention is limited only by the claims that follow.

We claim:

1. A computer implemented method for managing redundant email, comprising:
determining whether a first email is contained in a second email; and
purging the first email responsive to a determination that the first email is contained in the second email.

2. The method of claim 1, wherein determining whether a first email is contained in a second email comprises comparing subject line text of the first email with subject line text of the second email.

3. The method of claim 1, wherein determining whether a first email is contained in a second email comprises comparing text from the first email with text from the second email.

4. The method of claim 3, wherein comparing text from the first email with text from the second email comprises comparing a hashed value computed using text selected from the first email with a hashed value computed using text selected from the second email.

5. The method of claim 1, wherein determining whether a first email is contained in a second email comprises comparing subject line text of the first email with subject line text of the second email, and, if the subject line text of the first email and the subject line text of the second email are found to be substantially similar, comparing text from the first email with text from the second email.

6. The method of claim 1, further comprising transferring an attachment from the first email to the second email if the first email is to be purged and the attachment is absent from the second email.

7. A computer implemented method for managing redundant email, comprising:
grouping email having substantially the same subject line text to provide a group;
sorting the group according to timestamps to provide a sequence of email according to timestamps;
comparing text of adjacent members of the sequence to determine whether text of a first email in the group is contained in text of a second email in the group, wherein the first email and the second email are adjacent in the sequence according to timestamps; and
purging the first email if the text of the first email is determined to be contained in the text of the second email.

8. The method of claim 7, further comprising transferring an attachment from the first email to the second email if the first email is to be purged and the attachment is absent from the second email.

9. A computer program product for managing redundant email, the computer program product comprising a computer readable medium having computer readable program code tangibly embedded therein, the computer readable program code comprising:
computer readable program code configured to determine whether a first email is contained in a second email; and
computer readable program code configured to purge the first email responsive to a determination that the first email is contained in the second email.

10. The computer program product of claim 9, wherein the computer readable program code configured to determine whether a first email is contained in a second email comprises computer readable program code configured to compare subject line text of the first email with subject line text of the second email.

11. The computer program product of claim 9, wherein the computer readable program code configured to determine whether a first email is contained in a second email comprises computer readable program code configured to compare text from the first email with text from the second email.

12. The computer program product of claim 11, wherein the computer readable program code configured to compare text from the first email with text from the second email comprises computer readable program code configured to compare a hashed value computed using text from the first email with a hashed value computed using text from the second email.

13. The computer program product of claim 9, wherein the computer readable program code configured to determine whether a first email is contained in a second email comprises computer readable program code configured to compare subject line text of the first email with subject line text of the second email, and, if the subject line text of the first email and the subject line text of the second email are found to be substantially similar, to compare text from the first email with text from the second email.

14. The computer program product of claim 9, wherein the computer readable program code further comprises computer readable program code configured to transfer attachments from the first email to the second email if the first email is to be purged and the attachment is absent from the second email.
